(19) United States
(12) Patent Application Publication
(10) Pub. No.: US 2015/0242665 A1
(43) Pub. Date: Aug. 27, 2015

(54) PROXIMITY TAG WITH MULTIPLE ANTENNAS

(71) Applicant: ACCO Brands Corporation, Lake Zurich, IL (US)

(72) Inventors: Sorin Daniel A. Antonescu, Burnaby (CA); Gerald A. Gutierrez, Richmond (CA); Samson Lee, Vancouver (CA)

(73) Assignee: ACCO Brands Corporation, Lake Zurich, IL (US)

(21) Appl. No.: 14/187,809

(22) Filed: Feb. 24, 2014

(51) Int. Cl. G06K 7/10; G08B 21/24; G08B 25/10

(52) U.S. Cl. CPC G06K 7/10356; G08B 25/10; G08B 21/24

(57) ABSTRACT

A wireless device configured to communicate with a mobile communication device in an object tracking system includes a transceiver configured to send and receive messages with the mobile communication device. Each message has a signal strength value. The wireless device also includes a first antenna coupled to the transceiver for sending and receiving the messages, a second antenna coupled to the transceiver for alternatively sending and receiving the messages, and a processor coupled to the transceiver. The processor is operable to switch between using one of the first antenna and the second antenna based on the signal strength value of an associated message.

### BACKGROUND

The present invention relates to tracking systems used to prevent theft or loss of personal objects. In particular, personal objects can include identity papers, mobile electronics, and other important objects such as purses, wallets, etc. Day-to-day activities present many distractions that make loss and theft of personal objects common. Additionally, locating such lost or stolen objects is highly inconvenient.

Accordingly, it is desirable to provide a fast, easy, and effective system for tracking objects prior to their loss. Object tracking systems, however, sometimes generate false alarms due to environmental disturbances. The communication link used to track personal objects may be subjected to impairments such as multipath fading when working indoors or other crowded environments, and antenna detuning when working in close vicinity with the human body or other objects. These impairments affect the quality of the communication link possibly leading to unwanted false alarms.

### SUMMARY

In one embodiment, the invention provides a wireless device configured to communicate with a mobile communication device in an object tracking system. The wireless device includes a transceiver configured to send and receive messages with the mobile communication device, where each message has a signal strength value. The wireless device also includes a first antenna coupled to the transceiver for sending and receiving the messages, a second antenna coupled to the transceiver for alternatively sending and receiving the messages, and a processor coupled to the transceiver. The processor is operable to switch between using one of the first antenna and the second antenna based on the signal strength value of an associated message.

In another embodiment, the invention provides an object tracking system including a mobile communication device and a wireless device. The mobile communication device includes a first transceiver, a first antenna coupled to the first transceiver, and a first processor coupled to the first transceiver. The wireless device includes a second transceiver operable to communicate with the first transceiver for sending and receiving messages with the mobile communication device, each message having a signal strength value. The wireless device also includes a second antenna coupled to the second transceiver for sending and receiving the messages, a third antenna coupled to the second transceiver for alternatively sending and receiving the messages, and a second processor coupled to the second transceiver. The second processor is operable to switch between using one of the second antenna and the third antenna based on a signal strength value of an associated message.

In a third embodiment, the invention provides a method of improving signal strength between a mobile communication device and a wireless device. The wireless device includes a transceiver, a first antenna, a second antenna, and a processor. The method includes measuring a signal strength value of a message associated with the first antenna, measuring a signal strength value of a message associated with the second antenna, comparing the signal strength value of the message associated with the second antenna to the signal strength value of the message associated with the first antenna, and using one of the first antenna and the second antenna to communicate with the mobile communication device based on the signal strength value of the messages associated with the first and the second antenna.

Other aspects of the invention will become apparent by consideration of the detailed description and accompanying drawings.

### BRIEF DESCRIPTION OF THE DRAWINGS

FIG. 1 illustrates an object tracking system according to one embodiment of the invention.

FIG. 2 schematically illustrates a wireless device and a mobile communication device of the object tracking system.

FIG. 3 is a block diagram of the wireless device having a first arrangement of a first antenna and a second antenna.

FIG. 4 is a block diagram of the wireless device having a second arrangement of the first antenna and the second antenna.

FIG. 5 is a block diagram showing wireless communication between the wireless device and the mobile communication device.

FIG. 6 is a flow chart of a first embodiment of an antenna switching algorithm used by the wireless device.

FIG. 7 illustrates a flow chart of a second embodiment of the antenna switching algorithm used by the wireless device.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

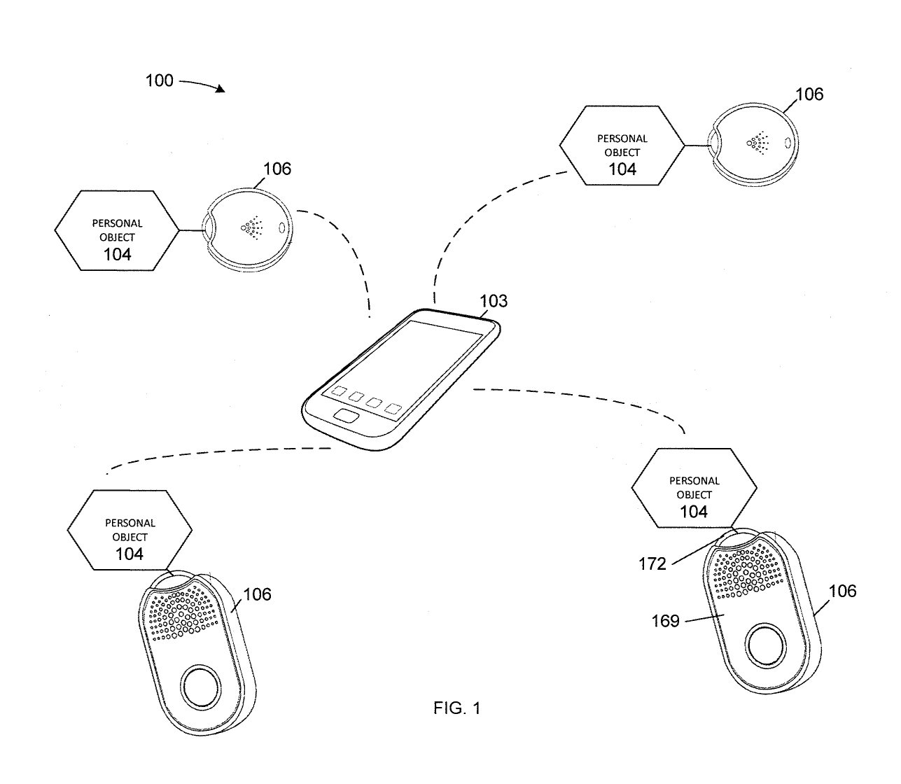

FIG. 1 illustrates an object tracking system 100. The object tracking system 100 is similar to the object tag proximity alert system disclosed in U.S. patent application Ser. No. 13/612,576, filed Sep. 12, 2012, the entire contents of which are incorporated by reference herein. The object tracking system 100 is generally used to prevent the loss of personal objects by alerting a user when a particular object is no longer within a specified radius of the user.

The illustrated object tracking system 100 includes a mobile communication device 103 and at least one wireless device 106. Each wireless device 106 attaches to a personal object 104 (e.g., keys, a purse, luggage, a briefcase, etc.). The mobile communication device 103 monitors and manages the at least one wireless device 106 attached to one or more personal objects 104. The wireless devices 106 and the mobile communication device 103 communicate periodically using short range wireless communication, for example, BLUETOOTH low energy communication. The mobile communication device 103 receives a wireless signal from each wireless device 106 and monitors a signal strength value (e.g., a received signal strength indicator (RSSI)) of the wireless message. The mobile communication device 103 also alerts a user when the signal strength value of a message drops below a predetermined threshold (i.e., an “alarm” or “disconnection” threshold). In general, the signal strength value decreases based upon several factors, including a distance between the mobile communication device 103 and the wireless device 106. Thus, the object tracking system 100 allows a user to monitor one or more personal objects by attaching each personal object to a different wireless device 106a-d, and alerts a user when a particular wireless device 106 is no longer in close proximity to the mobile communication device 103.

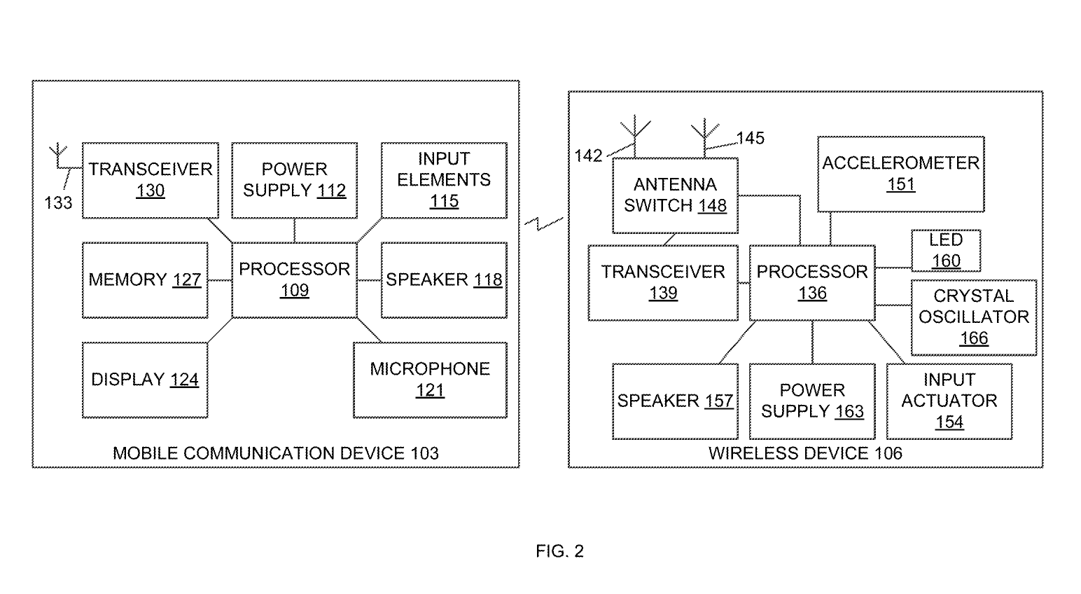

The mobile communication device 103 may be, for example, a smartphone, a smartwatch, a tablet computer, a laptop computer, a cellphone, a two-way radio, or any other electronic device capable of sending and receiving short range wireless signals to the wireless device 106. In the illustrated embodiment, the mobile communication device 103 is a smartphone. As shown in FIG. 2, the mobile communication device 103 includes a processor 109, a power supply 112, input elements 115, a speaker 118, a microphone 121, a display 124, memory 127, a short range transceiver 130, and an antenna 133 coupled to the transceiver 130. The transceiver 130 may be a chip, card, or any other device configured to send and receive short range wireless messages using the antenna 133. In the illustrated embodiment, the antenna 133 is a BLUETOOTH antenna.

The mobile communication device 103 generates a graphical user interface that is displayed on the display 124 of the mobile communication device 103. The input elements 115 allow a user to interact with the mobile communication device 103 through the graphical user interface. The input elements 115 may include buttons, switches, sensors, and the like. The input elements 115 enable a user to control the functionality of the mobile communication device 103. The microphone 121 may be used by the mobile communication device 103 to receive sound signals. The sounds signals may be used by the mobile communication device 103 as instructions to be fulfilled by the mobile communication device 103, or the sound signals may simply be transmitted or another electronic device, for example, a second mobile communication device 103. The speaker 118 allows the mobile communication device 103 to output signals to a user. For example, the speaker 118 of the mobile communication device 103 may be used by the object tracking system 100 to alert a user when a wireless device 106 is outside a specified radius of the mobile communication device 103. In other embodiments, the mobile communication device 103 may also include other output elements such as, for example, a vibrating element. The memory 127 of the mobile communication device 103 may include a non-transitory computer readable medium in which data and instructions for use by the processor 109 of the mobile communication device 103 may be stored. The power supply 112 of the mobile communication device 103 provides power to all of the components of the mobile communication device 103. The power supply 112 of the mobile communication device 103 may be a replaceable and/or rechargeable battery.

The processor 109 of the mobile communication device 103 is coupled to the transceiver 130 and is configured to monitor the signal strength value (RSSI) of short range wireless messages received by the transceiver 130 from the wireless device 106. The processor 109 is also configured to compare the RSSI value of each wireless message to predetermined thresholds to infer information regarding the status and/or location of the wireless device 106.

The wireless device 106 can be any electronic device that is configured to communicate with the mobile communication device 103. The wireless device 106 is often referred to as a tag or a fob. As shown in FIG. 2, the wireless device 106 includes a processor 136, a short range transceiver 139, a first short range antenna 142 coupled to the transceiver 139, a second short range antenna 145 also coupled to the transceiver 139, and an antenna switch 148 coupled to the first antenna 142, the second antenna 145, the transceiver 139, and the processor 136. The first antenna 142 and the second antenna 145 are configured to send and receive wireless messages of the same type (e.g., BLUETOOTH messages) to and from the mobile communication device 103.

In the illustrated embodiment, the wireless device 106 also includes other components coupled to the processor 136 of the wireless device 106, including an accelerometer 151, an input actuator 154, a speaker 157, a light emitting diode 160, a power supply 163, and a crystal oscillator 166. The crystal oscillator 166 provides a clock for the transceiver 139. The accelerometer 151 measures movement of the wireless device 106 and sends an indication of movement to the processor 136 of the wireless device 106. The input actuator 154 may be in the form of a button or a switch. The input actuator 154 allows the user to control the functionality of the wireless device 106. For example, the input actuator 154 may control pairing, volume, and power of the wireless device 106. The speaker 157 and the light emitting diode (LED) 160 alert the user of a specific status of the wireless device 106. For example, the wireless device 106 may emit an alarm sound using the speaker 157. The wireless device 106 may, alternatively or additionally, flash the LED 160 in a predefined frequency or color to alert a user. In some embodiments, the wireless device 106 may also include a vibrating device to deliver a tactile alarm, for example vibration. The power supply 163 of the wireless device 106 supplies power to all the components of the wireless device 106. The power supply 163 of the wireless device 106 may be a replaceable and/or rechargeable battery.

The transceiver 139 of the wireless device 106 can be a chip, a card, or any other device configured to send and receive wireless signals to and from the mobile communication device 103 using at least one of the first short range antenna 142 and the second short range antenna 145. In the illustrated embodiment, the first and second antennas 142, 145 are BLUETOOTH antennas. The first and second antennas 142, 145 are positioned on different parts of the wireless device 106 and are selectively used by the transceiver 139 of the wireless device 106 for sending and receiving wireless messages to and from the mobile communication device 103.

The antenna switch 148 couples one of the first and second antennas 142, 145 to the transceiver 139 of the wireless device 106. The antenna switch 148 is movable between a first position and a second position. When the antenna switch 148 is in the first position, the transceiver 139 of the wireless device 106 communicates with the mobile communication device 103 using the first antenna 142. When the antenna switch 148 is in the second position, the transceiver 139 of the wireless device 106 communicates with the mobile communication device 103 using the second antenna 145. In some embodiments, the antenna switch 148 may be an electronic switch. In other embodiments, the antenna switch 148 may be a digital switch, such as a multiplexer. In yet other embodiments, the wireless device 106 does not include an antenna switch 148, and use of either the first antenna 142 or the second antenna 145 is controlled through the processor 136 of the wireless device directly.

The processor 136 of the wireless device 106 is operable to control communication between the mobile communication device 103 and the wireless device 106. The processor 136 of the wireless device 106 is coupled to the transceiver 139 of the wireless device 106 and is operable to respond to wireless messages from the mobile communication device 103. In some embodiments, the wireless signals from the mobile communication device 103 may include instructions for the wireless device 106. In such embodiments, the processor 136 of the wireless device 106 determines if and how to execute the received instructions.

The processor 136 of the wireless device 106 also controls the position of the antenna switch 148. In some embodiments, the processor 136 of the wireless device 106 implements a method to determine the position of the antenna switch 148, thereby selecting one of the first and second antennas 142, 145 used for communication with the mobile communication device 103. In other embodiments, the processor 136 of the wireless device 106 receives an instruction from the mobile communication device 103 that indicates the position of the antenna switch 148. Generally, the first antenna 142 is used by the transceiver 139 of the wireless device 106 as a default antenna. The default antenna is used for communication with the mobile communication device 103, unless the second, non-default antenna 145 shows a significant improved wireless communication with the mobile communication device 103. For example, when the wireless device 106 is first powered on or reset, the transceiver 139 of the wireless device 106 automatically communicates with the mobile communication device 103 using the first antenna 142. The transceiver 139 of the wireless device 106 continues to use the first antenna 142 until the RSSI value of messages sent and/or received using the first antenna 142 drops below a predetermined threshold (i.e., an antenna threshold) and the RSSI value of messages sent and/or received with the second antenna 145 remains above the predetermined threshold (i.e., the antenna threshold).

The processor 136 of the wireless device 106 may also manage other operations of the wireless device 106 including pairing, connecting, and performing mutual authentication with the mobile communication device 103, measuring and reporting a power status, reporting a movement indication, and generating audio, visual, and tactile indications and alerts.

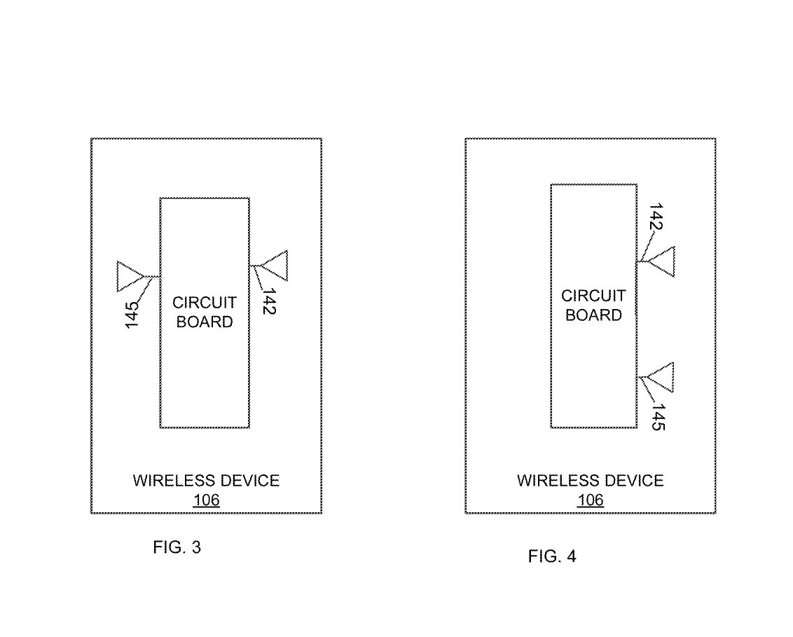

As shown in FIG. 1, the wireless device 106 includes a body 169 and an attachment device 172. The attachment device 172 allows the wireless device 106 to be easily and securably attached to a personal object 104. In the illustrated embodiment, the attachment device 172 is a keychain hole. All of the components of the wireless device 106 are supported by the body 169 such that the wireless device 106 is a self-contained unit. As shown in FIG. 3, in some embodiments, the first antenna 142 and the second antenna 145 are positioned on the same side of a circuit board, which contains most, if not all, of the components of the wireless device 106. As shown in FIG. 4, in other embodiments, the first antenna 142 and the second antenna 145 are positioned on opposite sides of the circuit board. The position of the first antenna 142 and the second antenna 145 is selected based on a particular application of the object tracking system 100.

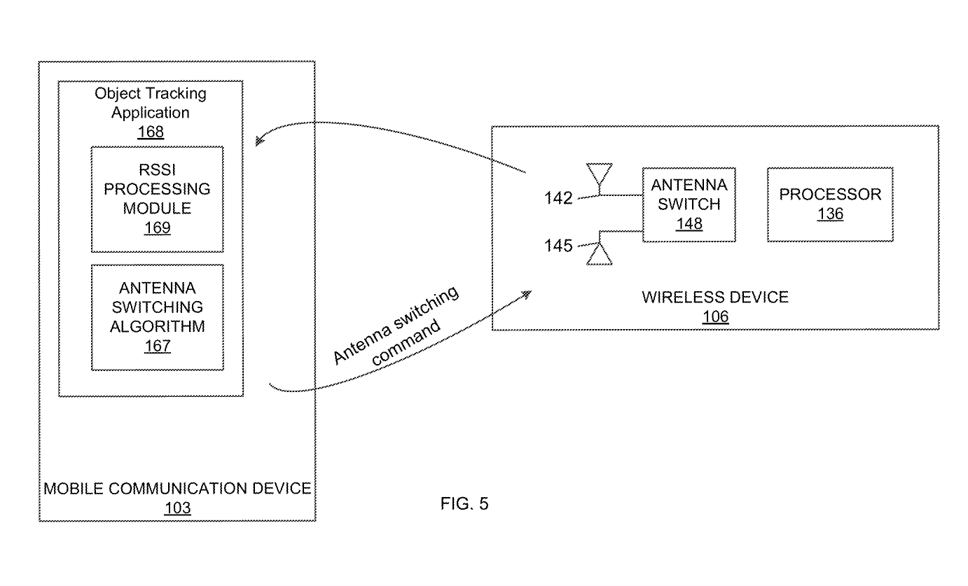

As shown in FIG. 5, the mobile communication device 103 hosts an object tracking application 175. In some embodiments, the object tracking application 175 may be hosted directly on the mobile communication device 103. In other embodiments, the mobile communication device 103 may connect to a network, for example the Internet, to access the object tracking application 175. In yet other embodiments, some aspects of the object tracking application 175 may be hosted by the mobile communication device 103 and other aspects of the object tracking application 175 may be accessed through a network. The object tracking application 175 includes an RSSI module 178 and an antenna switching algorithm module 181.

The RSSI processing module 178 monitors the RSSI value of the wireless messages between the mobile communication device 103 and the wireless device 106. In some embodiments, the RSSI processing module 169 may also filter and condition the wireless signals before determining the RSSI values of the wireless messages. In some embodiments, the RSSI module 178 may also store a particular number of previously measured RSSI values.

The RSSI module 178 also compares the RSSI value of a wireless signal to particular thresholds, for example, an alarm threshold. The alarm threshold is based on a calculated distance between the mobile communication device 103 and the wireless device 106. Generally, the RSSI value of a wireless message decreases as the distance between the mobile communication device 103 and the wireless device 106 increases. The mobile communication device 103, the wireless device 106, or both may produce a text message, an alert sound, or a tactile notification to the user when the measured RSSI value of a wireless message is less than the alarm threshold, indicating that the distance between the mobile communication device 103 and the wireless device 106 is greater than a predetermined distance (e.g., 20 feet). The mobile communication device 103 uses the speaker 118, the display 124, and/or the vibration element to alert the user that the RSSI value is less than the alarm threshold. The wireless device 106 may also use the speaker 157, light emitting diode 160, and vibrating device to alert the user that the wireless device 106 is no longer within a specified radius of the mobile communication device 103.

Once alerted, the user may quickly regain possession of the personal object attached to the wireless device 106. In some embodiments, the user may stop the alarm using one of the mobile communication device 103 and the wireless device 106. In other embodiments, the RSSI module 178 automatically detects that the wireless device 106 is again in close proximity with the mobile communication device 103 and stops the alarm automatically. Thus, the alarm threshold prevents the loss or theft of the personal object 104 attached to the wireless device 106. A user may set different alarm thresholds for each wireless device 106. In some embodiments, the user may choose among a set of predetermined alarm thresholds. In other embodiments, the user may set a particular alarm threshold without being confined to predetermined options. The use may change the alarm threshold through a graphical user interface generated by the object tracking application 175.

Other factors such as, for example, transmission power and environmental interference may also lead to a decrease of the RSSI value of a wireless message between the wireless device 106 and the mobile communication device 103. The decrease of RSSI value of a wireless message may cause the object tracking system 100 to generate a false alert to a user. For example, the mobile communication device 103 may determine that the RSSI value of a wireless message is below the alarm threshold and alert the user, even though the decrease in RSSI value of the wireless message may only be due to low transmission power and/or high environmental interference. To make sure that the user is only alerted due to an increase in the distance between the mobile communication device 103 and the wireless device 106, the RSSI module 178 implements a “hold-off” period. When the RSSI value of a wireless message is detected to be below the alarm threshold, the RSSI module 178 waits for a predetermined period of time (i.e., the “hold-off” period) and then measures the RSSI value of a wireless signal again. If the newly measured RSSI value remains below the alarm threshold, the user is alerted through the mobile communication device 103, the wireless device 106, or both that the wireless device 106 is no longer within a specified distance of the mobile communication device 103. The hold-off period allows a temporary disturbance to be abated before alerting the user and thus, inhibits false alarms based on temporary environmental interference.

The RSSI module 178 may also implement another threshold (i.e., a buffer threshold) to compensate for slight changes in signal strength value due to small changes in environmental interference or to multipath fading. For example, when the RSSI value of a message from one of the first antenna 142 and the second antenna 145 approaches, but does not drop below the alarm threshold due to the distance between the wireless device 106 and the mobile communication device 103, the buffer threshold may be implemented to ensure that slight variances in environmental interference and/or multipath fading do not generate a false alarm. For example, environmental interference and/or multipath fading may cause a ±5 dB difference in a measured RSSI value even if the wireless device 106 and the mobile communication device 103 do not move with respect to each other. If the alarm threshold is set to −60 dB and, due to the distance between the wireless device 106 and the mobile communication device 103, the measured RSSI value is −58 dB, the RSSI value may naturally vary between −53 dB and −63 dB due to environmental interference and/or multipath fading even when the distance between the wireless device 106 and the mobile communication device 103 does not change. If the user was alerted every time the RSSI value of the wireless message is below the alarm threshold, several false alerts would be generated due to natural changes in the RSSI value of a wireless message. Thus, the buffer threshold inhibits a false alert from being generated due to normal variances in environmental interference and/or multipath fading.

The RSSI module 178 may also generate an alert or alarm based on the rate of movement of the wireless device 103. The mobile communication device 103 stores and compares a series of RSSI values, and determines a rate of movement of the wireless device 106 based on the change in RSSI values. If the rate of movement of the wireless device 103 exceeds a predetermined threshold, the mobile communication device 103 alerts the user that the wireless device 106 is quickly separating from the mobile communication device 103.

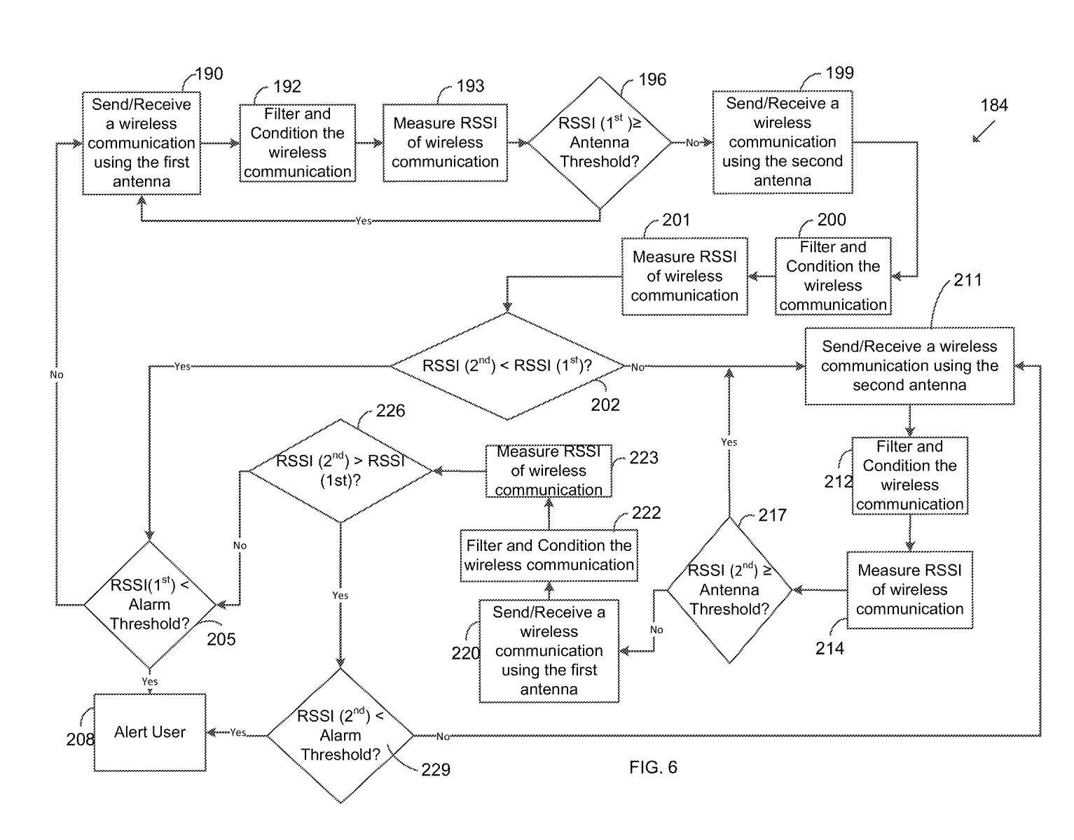

The RSSI value of a wireless message also decreases if the transceiver 139 of the wireless device 106 is using an antenna 142, 145 that is blocked, detuned, or damaged. As illustrated in FIG. 6, the antenna switching algorithm module 181 implements an antenna switching algorithm 184 that detects when an antenna 142, 145 of the wireless device 106 may be detuned, blocked, or damaged. If a blocked, damaged, or detuned antenna is detected, the antenna switching algorithm 184 couples a different antenna 142, 145 to the transceiver 139 of the wireless device 106 so that communication between the wireless device 106 and the mobile communication device 103 may continue. The antenna switching algorithm 184 compares the RSSI value of a wireless message with an antenna threshold to determine if the antenna 142, 145 coupled to the transceiver 139 of the wireless device 106 is detuned, damaged, or blocked. If the RSSI value of the wireless messages between the mobile communication device 103 and the wireless device 106 drops below an antenna threshold, the wireless device 106 communicates with the mobile communication device 103 using a different antenna 142, 145. In the illustrated embodiments, the mobile communication device 103 instructs the wireless device 106 to communicate with the mobile communication device 103 using a different antenna 142, 145. In other embodiments, the wireless device 106 implements the antenna switching algorithm 184 and communicates with the mobile communication device 103 using a different antenna 142, 145 without receiving instructions from the mobile communication device 103.

For example, if while the transceiver 139 of the wireless device 106 uses the first antenna 142 to communicate with the mobile communication device 103, the RSSI value of the wireless communication is below the antenna threshold, the antenna switching module 181 determines if a different antenna (e.g., the second antenna 145) provides a higher RSSI value. Accordingly, the wireless device 106 sends a wireless message to the mobile communication device 103 using the second antenna 145. The antenna switching module 181 determines which of the first antenna 142 and the second antenna 145 is used to communicate with the mobile communication device 103 and the wireless device 106. As shown in FIG. 5, in the illustrated embodiment, the mobile communication device 103 then sends a wireless message to the wireless device 106 instructing the wireless device 106 to use the antenna 142, 145 that yields a higher RSSI value.

Accordingly, the wireless device 106 changes the position of the antenna switch 148 to couple, or activate, one of the first antenna 142 and the second antenna 145 based on the instructions from the mobile communication device 103. Using the antenna 142, 145 that yields the higher RSSI value provides a more accurate approximation of the distance between the wireless device 106 and the mobile communication device 103 and may decrease the effects of environmental interference in wireless communication between the wireless device 106 and the mobile communication device 103. In some instances, the RSSI value associated with the first antenna 142 and the RSSI value associated with the second antenna 145 may not be significantly different. In such instances, the mobile communication device 103 instructs the wireless device 106 to continue using the first antenna 142, or the default antenna, for wireless communication.

In some embodiments, the wireless device 106 may include more than two antennas (i.e., three or more antennas). In such embodiments, the wireless device 106 may communicate with the mobile communication device 103 using each of the antennas to find a particular antenna that yields a higher RSSI value than the rest of the antennas. In such embodiments, the antenna switch 148 may be movable between more than two positions, such that each position of the antenna switch 148 activates a different antenna.

The antenna threshold is higher than the alarm threshold so that a blocked or damaged antenna can be detected before the RSSI value of a wireless message is below the alarm threshold. Accordingly, a more accurate RSSI value is used when comparing the RSSI value to the alarm threshold. Thus, the antenna switching algorithm 184 improves the quality of wireless messages transmitted between the mobile communication device 103 and the wireless device 106 and reduces the number of false alerts or alarms delivered to the user.

FIG. 6 illustrates the antenna switching algorithm 184 implemented by the object tracking application 175 and the implementation of the alarm threshold by the RSSI module 178. First, as shown at step 190, the wireless device 106 sends a wireless message to the mobile communication device 103 using the first antenna 142. Then the wireless message between the wireless device 106 and the mobile communication device 103 is filtered and conditioned (step 192) to reduce the amount of noise in the signal and thus obtain a more accurate RSSI value. The RSSI value of the filtered wireless message is then measured (step 193) and compared to the antenna threshold (step 196). If the RSSI value of a message associated with the first antenna 142 is greater than (i.e., is above) or equal to the antenna threshold, the wireless device 106 continues to send and receive wireless communication to and from the mobile communication device 103 using the first antenna 142 (step 190). If the RSSI value associated with the first antenna 142 is not greater than or equal to (i.e., is below) the antenna threshold, the wireless device 106 sends a wireless message to the mobile communication device 103 using the second antenna 145 (step 199). Then, the wireless message between the wireless device 106 and the mobile communication device 103 is filtered and conditioned (step 200), and measured (step 201). At step 202, the RSSI value of a message associated with the second antenna 145 is compared to the RSSI value of the message associated with the first antenna 142.

If the RSSI value of a message associated with the second antenna 145 is less than (i.e., is below) the RSSI value of a message associated with the first antenna 142, the RSSI value of a message associated with the first antenna 142 is compared to the alarm threshold (step 205). If the RSSI value associated with the first antenna 142 is less than (i.e., is below) the alarm threshold, the object tracking system 100 alerts a user using the mobile communication device 103, the wireless device 106, or both (step 208). If the RSSI value associated with the first antenna 142 is not less than (i.e., is greater than or equal to) the alarm threshold, the wireless device 106 continues to send and receive wireless messages to and from the mobile communication device 103 using the first antenna 142 (step 190).

Referring back to step 202, if the RSSI value associated with the second antenna 145 is not less than (i.e., is greater than or equal to) the RSSI value associated with the first antenna 142, the wireless device 106 sends and receives wireless messages using the second antenna 145 (step 211). The wireless messages from the second antenna 145 are filtered and conditioned (step 212). The RSSI value of the filtered wireless message associated with the second antenna 145 is then measured (step 214) and compared to the antenna threshold (step 217). If the RSSI value associated with the second antenna 145 is greater than (i.e., is above) or equal to the antenna threshold, the wireless device 106 continues to send and receive wireless signals using the second antenna 145 (step 211). If the RSSI value of a message associated with the second antenna 145 is not greater than or equal to (i.e., is below) the antenna threshold, the wireless device 106 sends and receives a wireless message using the first antenna 142 (step 220). The RSSI value of a message associated with the first antenna 142 is filtered and conditioned (step 222), and measured (step 223). The RSSI value of the wireless message associated with the first antenna 142 is then compared to the RSSI value associated with the second antenna 145 (step 226).

If the RSSI value associated with the second antenna 145 is greater than (i.e., is above) the RSSI value associated with the first antenna 142, the RSSI value associated with the second antenna 145 is compared to the alarm threshold (step 229). If the RSSI value associated with the second antenna 145 is less than (i.e., is below) the alarm threshold, the object tracking system 100 alerts the user as described above (step 208). If the RSSI value associated with the second antenna 145 is not less than (i.e., is above or equal to) the alarm threshold, the wireless device 106 continues to use the second antenna 145 to send and receive wireless messages to and from the mobile communication device 103 (step 211).

If the RSSI value associated with the second antenna 145 is not greater than (i.e., is below or equal to) the RSSI value associated with the first antenna 142, the RSSI value associated with the first antenna 142 is compared to the alarm threshold as described above (step 205). Therefore, the antenna switching algorithm 184 measures the RSSI values of a message associated with the first antenna 142 and of a message associated with the second antenna 145, and uses the higher RSSI value from one of the first antenna 142 and the second antenna 145 to send and receive wireless messages between the wireless device 106 and the mobile communication device 103.

In other embodiments, the processor 136 of the wireless device 106 monitors the RSSI values of messages associated with the first antenna 142 and the second antenna 145. The processor 136 of the wireless device 106 can then implement the antenna switching algorithm 184 and does not receive instructions from the mobile communication device 103 to use the first antenna 142 or to use the second antenna 145. In some embodiments, the wireless device 106 may include more than two antennas (i.e., three or more antennas). In such embodiments, the antenna switching algorithm 184 compares the RSSI values associated with each antenna and uses the antenna that yields a higher RSSI value than the rest of the antennas to communicate with the mobile communication device 103.

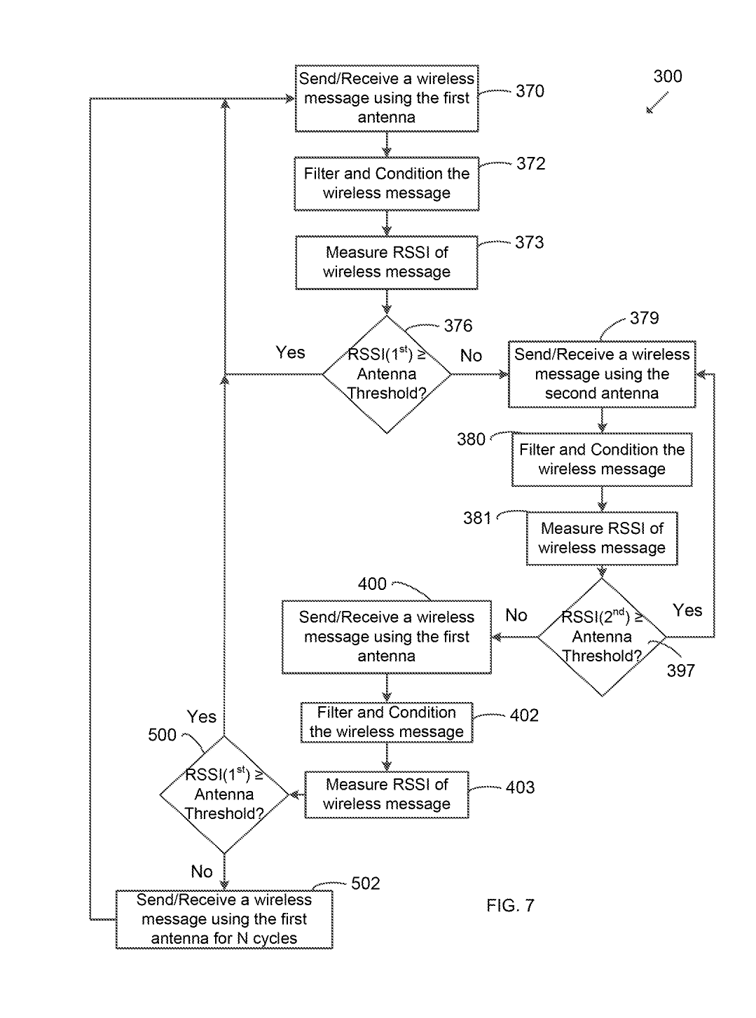

FIG. 7 illustrates another antenna switching algorithm 300 that can be implemented by the mobile communication device 103 and/or the wireless device 106. The illustrated antenna switching algorithm 300 includes similar steps as the antenna switching algorithm 184 described above with reference to FIG. 6. All other operations of the wireless device 106 and the mobile communication device 103 not explicitly disclosed below are the same, including the implementation of the alarm threshold.

In the illustrated embodiment, the wireless device 106 sends and receives a wireless message using the first antenna 142 (step 370). The wireless message is then filtered and conditioned (step 372). The RSSI value of the filtered message is then measured (step 373) and compared to the antenna threshold (step 376).

If the RSSI value associated with the first antenna 142 is greater than (i.e., is above) or equal to the antenna threshold the wireless device 106 continues to send and receive messages to and from the mobile communication device 103 using the first antenna 142 (step 370). If the RSSI value associated with the first antenna 142 is not greater than or equal to (i.e., is below) the antenna threshold, the wireless device 106 sends a wireless message to the mobile communication device 103 using the second antenna 145 (step 379). The wireless message from the second antenna 145 is then filtered and conditioned (step 380). The RSSI value of the message associated with the second antenna 145 is then measured (step 381) and compared to the antenna threshold (step 397).

If the RSSI value associated with the second antenna 145 is greater than (i.e., is above) or equal to the antenna threshold, the wireless device 106 continues to send and receives wireless messages to and from the mobile communication device 103 using the second antenna 145 (step 379). If the RSSI value associated with the second antenna 145 is not greater than or equal to (i.e., is below) the antenna threshold, the wireless device 106 sends a wireless message to the mobile communication device 103 using the first antenna 142 (step 400). The wireless message associated with the first antenna 142 is then filtered and conditioned (step 402). The RSSI value of the filtered wireless message associated with the first antenna 142 is then measured (step 403) and compared to the antenna threshold (step 500).

If the RSSI value associated with the first antenna 142 is greater than (i.e., is above) or equal to the antenna threshold, the wireless device 106 continues to send and receive wireless messages to and from the mobile communication device 103 using the first antenna 142 (step 370). If the RSSI value associated with the first antenna 142 is not greater than or equal to (i.e., is below) the antenna threshold (meaning that the RSSI value associated with the first antenna 142 and the RSSI value associated with the second antenna 145 are both below the antenna threshold), the wireless device 106 sends and receives wireless messages using the first antenna 142 for a predetermined number N of cycles (e.g., 25 cycles) (step 502) to allow any temporary interferences to be removed, similar to the operation of the hold-off period described above. After the predetermined number N of cycles have passed, the antenna switching algorithm 300 restarts (step 370). During this time, if the RSSI value associated with the first antenna 142 drops below the alarm threshold, the mobile communication device 103 and/or the wireless device 106 will alert the user. Setting a predetermined number N of cycles inhibits the antenna switching algorithm from constantly switching back and forth between using the first antenna 142 and using the second antenna 145 if both the RSSI value associated with the first antenna 142 and the RSSI value associated with the second antenna 145 are below the antenna threshold, but still above the alarm threshold.

The antenna switching algorithm 300 indirectly compares the RSSI value associated with the first antenna 142 to the RSSI value associated with the second antenna 145 through the antenna threshold. Therefore, while the first antenna switching algorithm 184 uses the higher RSSI value of a message associated with one of the first antenna 142 and the second antenna 145, the second switching algorithm 300 uses the first antenna 142 if both the RSSI value associated with the first antenna 142 and the RSSI value associated with the second antenna 145 are below the antenna threshold, even if the RSSI value associated with the second antenna 145 is higher than the RSSI value associated with the first antenna 142.

The second antenna switching algorithm 300 may be used, for example, in embodiments for which the difference between the antenna threshold and the alarm threshold is relatively small. In such embodiments, only one of the antennas (e.g., the first antenna 142) is checked against the alarm threshold. In addition, the second antenna switching algorithm 300 may be used in embodiments in which both the first antenna 142 and the second antenna 145 operate relatively close the antenna threshold. In such embodiments, rather than switching back and forth between using the first antenna 142 and the second antenna 145, the antenna switching algorithm 300 uses only one antenna (e.g., the first antenna 142) for a predetermined number of cycles.

In some embodiments, the wireless device 106 may include more than two antennas (i.e., three or more antennas). In such embodiments, the antenna switching algorithm 300 compares the RSSI values associated with each antenna to the antenna threshold and, thereby, determines which antenna to use for communication between the wireless device 106 and the mobile communication device 103. The antenna switching algorithm 300 can still have a default antenna (e.g., the first antenna 142) that is used if all of the antennas are below the antenna threshold.

Various features and advantages of the invention are set forth in the following claims.

What is claimed is:

1. A wireless device configured to communicate with a mobile communication device in an object tracking system, the wireless device comprising:
a transceiver configured to send and receive messages with the mobile communication device, each message having a signal strength value;
a first antenna coupled to the transceiver for sending and receiving the messages;
a second antenna coupled to the transceiver for alternatively sending and receiving the messages; and
a processor coupled to the transceiver, the processor operable to switch between using one of the first antenna and the second antenna based on the signal strength value of an associated message.

2. The wireless device of claim 1, wherein the processor switches to use the one of the first antenna and the second antenna that sends and receives messages having higher signal strength values.

3. The wireless device of claim 1, wherein the transceiver is configured to send and receive messages with the mobile communication device using only one of the first antenna and the second antenna at a time.

4. The wireless device of claim 1, wherein the first antenna and the second antenna are used to send and receive wireless messages of a same type.

5. The wireless device of claim 1, wherein the processor is configured to receive a signal from the mobile communication device to switch between using one of the first antenna and the second antenna.

6. The wireless device of claim 1, wherein the processor is configured to communicate with the mobile communication device using the second antenna when the signal strength value of an associated message using the first antenna is below an antenna threshold.

7. The wireless device of claim 6, wherein the processor is configured to communicate with the mobile communication device using the first antenna if the signal strength value of an associated message using the second antenna is below the antenna threshold.

8. The wireless device of claim 7, wherein the mobile communication device is configured to alert a user if the signal strength value of the associated message from the first antenna is below an alarm threshold.

9. The wireless device of claim 8, wherein the alarm threshold is lower than the antenna threshold.

10. The wireless device of claim 1, further comprising a switch coupled to the processor, the first antenna, and the second antenna, wherein the switch selectively connects one of the first antenna and the second antenna to the transceiver, and wherein the processor is operable to control a position of the switch.

11. The wireless device of claim 1, further comprising a body, wherein the transceiver, the first antenna, the second antenna, and the processor are supported by the body.

12. The wireless device of claim 1, wherein the processor is operable to compare the signal strength value of an associated message using the first antenna to an antenna threshold, and compare the signal strength value of an associated message using the second antenna to the antenna threshold.

13. An object tracking system comprising:
a mobile communication device, the mobile communication device including
a first transceiver,
a first antenna coupled to the first transceiver, and
a first processor coupled to the first transceiver; and
a wireless device, the wireless device including
a second transceiver operable to communicate with the first transceiver for sending and receiving messages with the mobile communication device, each message having a signal strength value,
a second antenna coupled to the second transceiver for sending and receiving the messages,
a third antenna coupled to the second transceiver for alternatively sending and receiving the messages, and
a second processor coupled to the second transceiver, the second processor operable to switch between using one of the second antenna and the third antenna based on the signal strength value of an associated message.

14. The object tracking system of claim 13, wherein the second processor switches to use one of the second antenna and the third antenna that sends and receives messages having higher signal strength values.

15. The object tracking system of claim 13, wherein the second transceiver sends and receives messages with the first transceiver using only one of the second antenna and the third antenna at a time.

16. The object tracking system of claim 13, wherein the first, second, and third antennas are short-range antennas.

17. The object tracking system of claim 13, wherein the second transceiver communicates with the first transceiver using the third antenna when the signal strength value of an associated message using the second antenna is below an antenna threshold, and wherein the second transceiver communicates with the first transceiver using the second antenna if the signal strength value of an associated message using the third antenna is below the antenna threshold.

18. The object tracking system of claim 17, wherein the mobile communication device alerts a user if the signal strength values of the associated message from the first antenna is below an alarm threshold, and wherein the alarm threshold is lower than the antenna threshold.

19. The object tracking system of claim 13, wherein the first processor is operable to
compare the signal strength value of an associated message when the wireless device is using the second antenna to the signal strength value of an associated message when the wireless device is using the third antenna,
determine which of the signal strength values is higher, and
send a signal to the second processor to use the one of the first antenna and the second antenna with the higher signal strength value.

20. The object tracking system of claim 13, wherein the second processor is operable to
compare the signal strength value of an associated message when the wireless device is using the second antenna to an antenna threshold, and
compare the signal strength value of an associated message when the wireless device is using the third antenna to the antenna threshold.

21. The object tracking system of claim 13, wherein the wireless device further includes a switch coupled to the second processor, the second antenna, and the third antenna, wherein the switch selectively connects the one of the second antenna and the third antenna to the second transceiver, and wherein the second processor is operable to control a position of the switch.

22. A method of improving signal strength between a mobile communication device and a wireless device, the wireless device including a transceiver, a first antenna, a second antenna, and a processor, the method comprising:
measuring a signal strength value of a message associated with the first antenna;
measuring a signal strength value of a message associated with the second antenna;
comparing the signal strength value of the message associated with the second antenna to the signal strength value of the message associated with the first antenna; and
using one of the first antenna and the second antenna to communicate with the mobile communication device based on the signal strength values of the messages associated with the first and the second antennas.

23. The method of claim 22, wherein using one of the first antenna and the second antenna includes switching to use the one of the first antenna and the second antenna associated with a higher signal strength value.

24. The method of claim 23, further comprising receiving a signal from the mobile communication device at the wireless device to switch between using the one of the first antenna and the second antenna.

25. The method of claim 22, wherein comparing the signal strength value associated with the second antenna to the signal strength value associated with the first antenna includes
comparing the signal strength value associated with the first antenna to an antenna threshold,
switching to use the second antenna if the signal strength value associated with the first antenna is less than the antenna threshold,
comparing the signal strength value associated with the second antenna to the antenna threshold, and
switching back to use the first antenna if the signal strength value associated with the second antenna is less than the antenna threshold.

26. The method of claim 25, further comprising alerting a user if the signal strength values associated with the first antenna is below an alarm threshold, wherein the alarm threshold is less than the antenna threshold.
